(19) United States
(12) Patent Application Publication
(10) Pub. No.: US 2013/0275201 A1
(43) Pub. Date: Oct. 17, 2013

(54) APPARATUSES AND METHODS FOR A UNIVERSAL CONSUMER CARD REDEMPTION SYSTEM WITH SINGLE BUTTON REDEMPTION

(71) Applicant: KOSTIZI, INC., Salt Lake City, UT (US)

(72) Inventors: Max K. Goff, Salt Lake City, UT (US); Nicholas J. Call, Salt Lake City, UT (US); John P. Saltas, Murray, UT (US); Jeffrey A. Reese, Salt Lake City, UT (US)

(73) Assignee: KOSTIZI, INC., Salt Lake City, UT (US)

(21) Appl. No.: 13/842,062

(22) Filed: Mar. 15, 2013

Related U.S. Application Data
(60) Provisional application No. 61/624,821, filed on Apr. 16, 2012.
(60) Provisional application No. 61/624,810, filed on Apr. 16, 2012.
(60) Provisional application No. 61/624,789, filed on Apr. 16, 2012.

(51) Int. Cl. G06Q 30/02

(52) U.S. Cl. CPC G06Q 30/0233
USPC 705/14.33

(57) ABSTRACT

Methods and associated systems related to generating, managing, and accessing data related to contractual obligations of a consumer and a plurality of different merchants in a universal consumer card redemption system are disclosed. A universal consumer card redemption system may comprises a universal software platform including a network of linked databases configured to store data associated with contractual relationships between at least one consumer and a plurality of different merchants, and at least one web-based interface configured to communicate with at least one universal consumer card associated with a consumer and at least one web-enabled device associated with a merchant. The at least one web-enabled device may include a single-button redemption capability, wherein a plurality of offers and redemption options are presented via a single interface.

### CROSS-REFERENCE TO RELATED APPLICATIONS

This application claims the benefit of U.S. Provisional Patent Application Ser. No. 61/624,821, filed Apr. 16, 2012, the disclosure of which is hereby incorporated herein in its entirety by this reference.

The subject matter of this application is also related to the subject matter of U.S. patent application Ser. No. ______ (attorney docket 3542-11321.1US) filed Mar. 15, 2013, and entitled, “Universal Consumer Card Offer and Redemption System and Related Method,” and U.S. patent application Ser. No. ______, (attorney docket 3542-11320.1US) filed Mar. 15, 2013, and entitled, “Apparatuses and Methods for a Hybrid Universal Consumer Card Redemption System,” the disclosure of each of which is incorporated herein by this reference in its entirety.

### TECHNICAL FIELD

The disclosure generally relates to universal consumer card management. More particularly, embodiments of the disclosure relate to systems for universal management and redemption using a universal consumer card for assets related to one or more different merchants.

### BACKGROUND

It is not uncommon for consumers to be found with a wallet bulging with various bankcards, merchant cards, organizational membership cards, gift cards, reward cards, other similar cards having information associated therewith. In addition, consumers may be in possession of a number of paper certificates, such as coupons, gift certificates, event tickets, deal vouchers, etc. The large number of such cards and paper certificates may take up space and provide an organizational nightmare for both consumers and merchants.

From the consumer's perspective, keeping track of such cards and paper certificates can prove difficult in tracking balances, expiration dates, often leading to the balances expiring, resulting in the credits being unused. In addition, such cards and paper certificates often become lost, which generally results in the consumer effectively losing cash. In addition, consumers may be discouraged from using such cards and certificates for reasons such as coupon stigma, potential redemption quarrels, or the inconvenience of needing to be at a particular terminal to buy or print the card or certificate.

From the merchant's perspective, keeping track of paper certificates during redemption (e.g., deal space redemption) may prove difficult in keeping track of papers and verifying data to close a register at the end of the day. In addition, such systems may provide opportunity for consumers to provide fraudulent paper certificates, which may require additional training for employees to recognize paper certificates as fraudulent. Employee fraud is another concern of merchants using conventional methods of deal space redemption. The merchant may also lack redemption metrics regarding the consumer, including which issued certificates have been redeemed and which certificates remain outstanding. Each of these potential problems may result in a lost profit, wasting time and other resources, and losing opportunity for obtaining desirable information regarding certain transactions.

Conventional universal consumer cards (also called multiple purpose cards) may address at least some of these problems, in that conventional universal consumer cards may attempt to consolidate balances from different merchants to be accessible by a single card. Conventional universal consumer cards may fall short in terms of universal accessibility and redemption. For example, if integrated with a “closed loop” redemption systems (e.g., vertical systems that are accessible by a specific card system), costly reprogramming Point of Sale (POS) terminals or installing new card readers may be required by the merchant, which may discourage merchant participation in providing offers for the conventional universal consumer cards. In addition, integrating conventional universal consumer cards with “open loop” redemption systems (e.g., horizontal systems that accessible by multiple card systems) has proven challenging in using existing equipment (e.g., existing credit card readers) because of the expense and difficulty in having such existing equipment recognize and distinguish between regular single purpose cards (e.g., credit cards, debit cards, single merchant gift cards, etc.) and the data stored for use with the conventional universal cards.

### SUMMARY

In some embodiments, a universal consumer card redemption system is disclosed. The system comprises a universal software platform including a network of linked databases configured to store data associated with contractual relationships between at least one consumer and a plurality of different merchants. The system further comprises at least one web-based interface configured to communicate with at least one of a universal consumer card associated with a consumer and web-enabled device associated with a merchant. The at least one web-based interface provides the web-enabled device with a single-button redemption feature configured to present at least one asset of the consumer for a particular merchant and redemption options to the merchant responsive to receiving a query request via an interface of the web-enabled device.

In another embodiment, a web-enabled device configured for use with a universal card redemption system is disclosed. The web-enabled device is configured to display an interface to a merchant, the interface having a single button redemption feature, query a plurality of linked databases to determine an existence of at least one asset of a particular consumer associated with the merchant in response to the single button redemption feature being selected, and display the at least one asset of the particular customer associated with the merchant in response to the query.

In another embodiment, a method for redeeming an asset from a consumer account is disclosed. The method comprises selecting a query button on an interface displayed by a web-enabled device, querying a database including data objects associated with a plurality of assets linked to a plurality of consumer accounts, receiving a list having at least one asset linked to a particular consumer account of the plurality that is associated with a particular merchant, and redeeming the asset through the interface.

### BRIEF DESCRIPTION OF THE OF THE DRAWINGS

FIG. 1 is a system for universal redemption of a universal consumer card according to an embodiment of the disclosure.

FIG. 2 shows one or more universal consumer card that may be assigned to a specific obligee account.

FIG. 3 illustrates information that may be associated with an asset in the appropriate entries of the linked databases if a new asset is added to the consumer's consumer account.

FIG. 4 illustrates information that may be available about registered and non-registered cards and the information that may be available to the consumer through the consumer account and the merchant through a merchant account.

FIG. 5 illustrates information that may be available to the consumer through the consumer account, as well as to each merchant through its respective merchant account.

FIG. 6 is a flow chart illustrating a method for establishing a contractual relationship between a consumer and a merchant according to an embodiment of the disclosure.

FIG. 7 is a flow chart illustrating a method for redeeming an asset of a consumer according to an embodiment of the disclosure.

FIG. 8 is a flow diagram illustrating a life span of an object generated with the creation of a non-fungible contractual liability between a consumer and a merchant.

### DETAILED DESCRIPTION

In the following description, reference is made to the accompanying drawings in which is shown, by way of illustration, specific embodiments of the disclosure. The embodiments are intended to describe aspects of the disclosure in sufficient detail to enable those skilled in the art to make, use, and otherwise practice the claimed invention. Other embodiments may be utilized and changes may be made without departing from the scope of the disclosure. The following detailed description is not to be taken in a limiting sense, and the scope of the claimed invention is defined only by the appended claims and their equivalents.

Furthermore, specific implementations shown and described are only examples and should not be construed as the only way to implement or partition the disclosure into functional elements unless specified otherwise herein. It will be readily apparent to one of ordinary skill in the art that the various embodiments of the disclosure may be practiced by numerous other partitioning solutions.

In the following description, modules, programs, and functions may be shown in block diagram faun in order not to obscure the disclosure in unnecessary detail. Additionally, block definitions and partitioning of logic between various blocks is exemplary of a specific implementation. It will be readily apparent to one of ordinary skill in the art that the disclosure may be practiced by numerous other partitioning solutions. The various illustrative logical blocks, modules, programs, and functions described in connection with the embodiments disclosed herein may be implemented or performed with a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A general-purpose processor may be considered a special-purpose processor while the general-purpose processor executes instructions (e.g., software code) stored on a computer-readable medium. A processor may also be implemented as a combination of computing devices, such as a combination of a DSP and a microprocessor, a plurality of microprocessors, one or more microprocessors in conjunction with a DSP core, or any other such configuration.

Also, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be re-arranged. A process may correspond to a method, a function, a procedure, a subroutine, a subprogram, etc. If implemented in software, the functions may be stored or transmitted as one or more instructions or code on computer readable media. Computer-readable media includes both computer storage media and communication media including any medium that facilitates transfer of a computer program from one place to another.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

As used herein, a non-fungible contractual obligation is an obligation that is a liability to an obligor and an asset to an obligee. For ease of discussion, an obligee may be referred to herein as a “user” or a “consumer,” whereas an obligor may be referred to as a “merchant.”

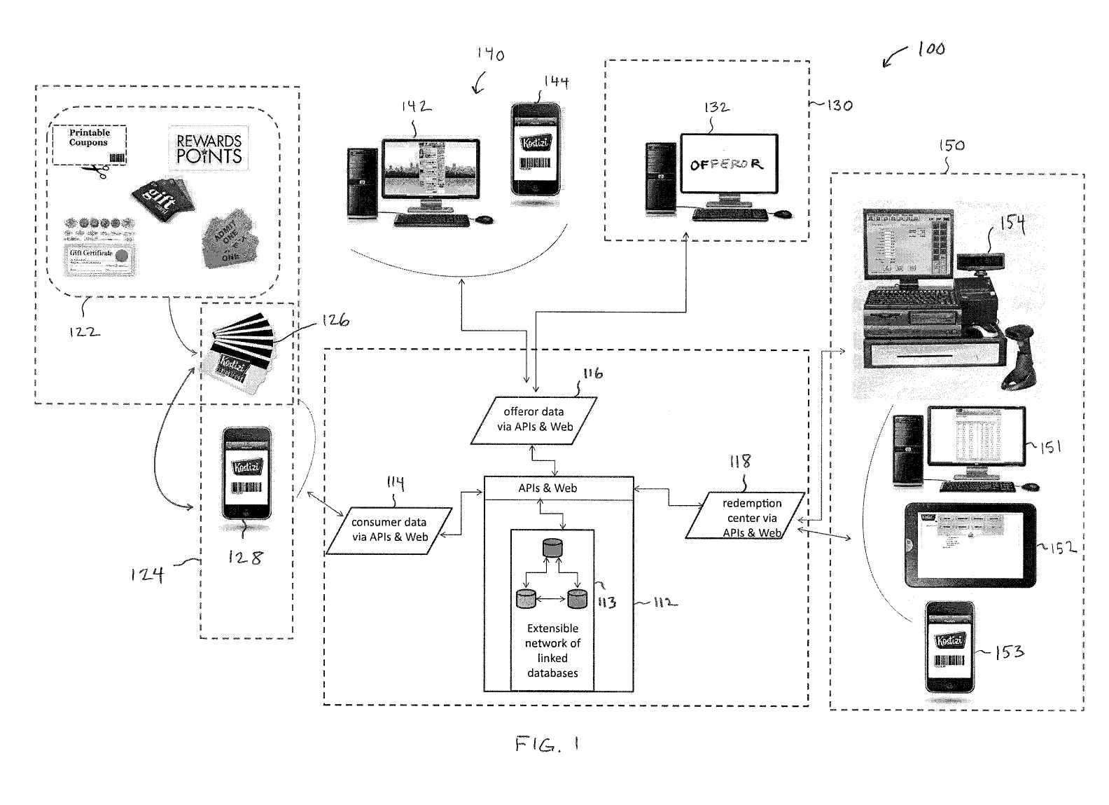

FIG. 1 is a system 100 for universal redemption of a universal consumer card according to an embodiment of the disclosure. The system 100 includes a card data and redemption center 110 that is configured to store and manage data relating to transactions using a universal consumer card. Thus, the card data and redemption center 110 may be integrated with a universal card system 120 that consolidates a plurality of balances for a consumer for storage and redemption through a universal consumer card 124.

The universal consumer card 124 may be configured as a physical universal consumer card 126 or a virtual (digital) universal consumer card 128. In some embodiments, the system 100 may be configured as a hybrid system that interacts with both physical universal consumer cards 126 and virtual universal consumer cards 126. Such a hybrid card system may enable a consumer to redeem assets associated with the physical universal consumer card 126 or a virtual universal consumer card 128 via Internet-based communication protocols to the card data and redemption center 110, according to one or more of the methods described below. As described above, conventional universal cards may have encountered challenges in integrating with either open loop or closed loop redemption systems.

The card data and redemption center 110 may include a universal redemption center software platform 112 that includes a network of linked databases 113 that communicate with outside parties through computer application programming interfaces (APIs) 114, 116, 118. The linked databases 113 and APIs 114, 116, 118 may be stored in a computer-readable medium (e.g., memory) of a server that is part of the card data and redemption center 110.

The APIs 114, 116, 118 use Internet data transfer protocols that generate and maintain cross-references, tracking, reporting, data transfer, fraud prevention, and redemption capabilities for the transactional adjustments of non-fungible, offeror-to-offeree contractual assets and liabilities. Thus, the data stored in the linked databases 113 may include appropriate data related to offeror-to-offeree non-fungible assets and liabilities and transactions thereof, which data may be made available to offerors, offerees, and third parties via the secure APIs 114, 116, 118. As a result, embodiments of the disclosure include a web-based universal consumer card management system that may be accessible by consumers, merchants, and third parties.

The system 100 may include a software platform that is configured to manage a consumer account to display assets associated with a plurality of different merchants, and associate at least one physical consumer card 126 and at least one virtual consumer card 128 with the consumer account, such that redemption of the assets the at least one physical consumer card or the at least one virtual consumer card. In a hybrid system, a consumer account may have both the at least one consumer card 126 and the at least one virtual consumer card 128 associated with the same consumer account. As a result, for redemption, the user may user either card-type for the same consumer account.

The software platform may further be configured to provide a web-based storefront configured to present a plurality of offers from the plurality of different merchants for purchase by a consumer. The software platform may be configured to enable the consumer to access their consumer account to purchase offers from any one of the plurality of different merchants, add balances to existing assets, and take other actions in viewing and managing the assets that may be available for redemption from a merchant. In addition, the software platform may be configured to manage a merchant account to display liabilities that the merchant has with respect to a plurality of different consumers.

The software platform may further be configured to receive redemption requests from a web-enabled device 150 operated by the merchant. The redemption request may be performed over the inter⁻net, bypassing the need for complicated conventional open loop or closed loop systems. The redemption request include the card data, asset/liability, and other attributes that may uniquely identify the consumer account, the asset for redemption, etc.

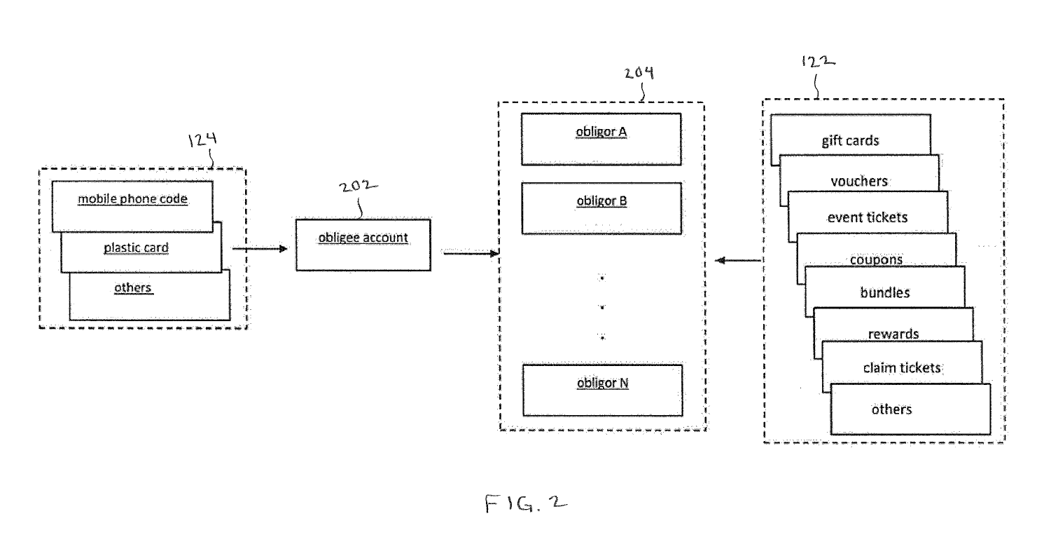

As shown in FIG. 2, one or more universal consumer cards 124 may be assigned to a specific obligee account 202, which may also be referred to as a “consumer account” or a “user account.” Through the consumer account 202, the consumer may access information (e.g., personal information of the consumer) as well as the assets 122 of the consumer that are associated with the consumer account 202. The assets 122 may be organized within the linked databases 113 (FIG. 1) according to the consumer and merchant to which the asset 122 applies. As will be discussed below in further detail, data objects may be generated with attributes, at least some of which may be unique to a particular asset 122, while other attributes may correspond to other information regarding transactions involving the data object.

As discussed above, the assets 122 may include non-fungible contractual obligations between a consumer and a merchant, wherein the consumer possesses the asset 122 and the appropriate merchant 204 possesses the corresponding liability until redemption occurs. Examples of non-fungible contractual obligations include, but are not limited to, gift cards/certificates, vouchers, event tickets, coupons, bungles, rewards, claim tickets, deals, fees, ownership claims for goods and services, pre-paid prescriptions, appointments, and other similar obligations. Such a list of assets 122 and balances is not to be viewed as an exhaustive list, and the system 100 may accommodate the transaction of any non-fungible offeror-to-offeree contractual asset/liability that can be uniquely identified, tracked, and redeemed, resulting in a reduction of a liability for the offeror, and redemption of value for the offeree. Therefore, other contractual assets/liabilities are contemplated. The balances for the assets 122 of a universal consumer card 124 may be associated with given consumer for a plurality of different merchants 204.

The consumer account 202 may be configured for a consumer to access (e.g., view, manage, redeem, etc.) balances for a plurality of different merchants 204 that are participants to the system 100. For example, consumers may log into the consumer account 202 (via an application, web site, etc.) to view existing balances, as well as other information related to the balances, such as merchant information, expiration date (if any) of balances, and so forth.

In some embodiments, consumers may also be permitted to add to the balances, such as by increasing the balance amount. Such management of balances may be performed by the consumer through the consumer account 202. For example, while logged into the consumer account 202, the consumer may purchase additional deals offered by merchants or third parties, enter coupon information, purchase an event ticket, add money to a gift card, and so forth. Such balances may be re-loadable. Entering into such a contractual relationship may likewise add assets 122 that are available for redemption by the consumer for the universal card 124. These additional assets 122 are seen as liabilities to the corresponding merchants.

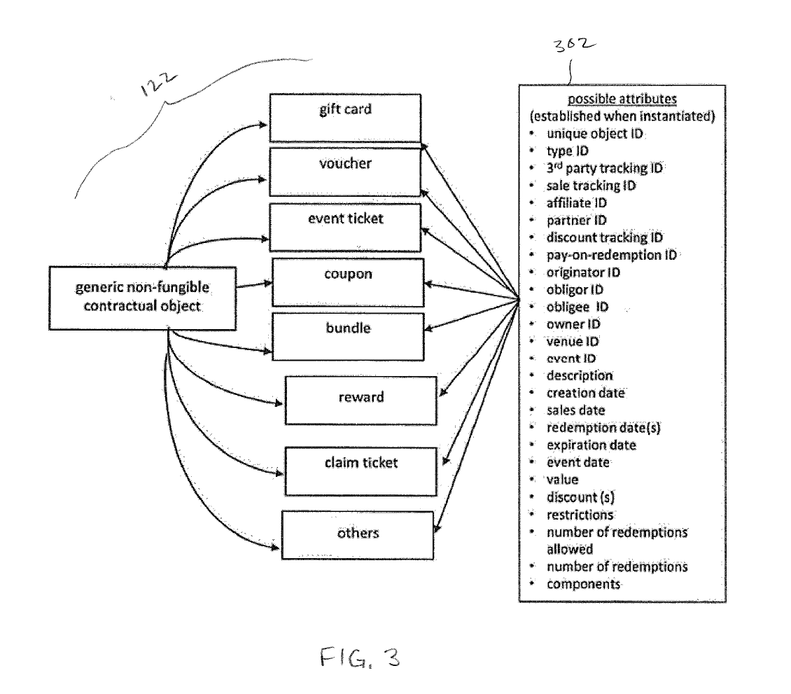

FIG. 3 illustrates information that may be associated with an asset 122 in the appropriate entries of the linked databases 113 (FIG. 1) if a new asset 122 is added to the consumer's consumer account 202. For example, the linked databases 113 may create an entry (e.g., data object) that may be parsed by the card data and redemption center 110 to uniquely identify the asset 202, associate with the appropriate consumer and merchant, and facilitate the management (including redemption) thereof. For example, examples of attributes that may be generated with the data object representing a new asset 122 when the data object is instantiated may include one or more of the following: a unique object ID, a type ID, third-party tracking ID, sale tracking ID, affiliate ID, partner ID, discount tracking ID, pay-on-redemption ID, originator ID, obligor ID, oblige ID, owner ID, venue ID, event ID, description, creation date, sales date, redemption date(s), expiration date, event date, value, discounts, restrictions, number of redemptions allowed, number of redemptions, components, and other data that may be desirable to identify and/or track. Many of the attributes may be updated over time, such as if balances are added to after the data object is created, if the balance is redeemed or at least partially redeemed, etc. The attributes associated with the data object may remain for that particular asset and may be parsed with the other data objects within the linked databases 113 to provide useful information to an administrator as well as merchants about the history of an asset 202, trends with a single consumer or a group of consumers, etc.

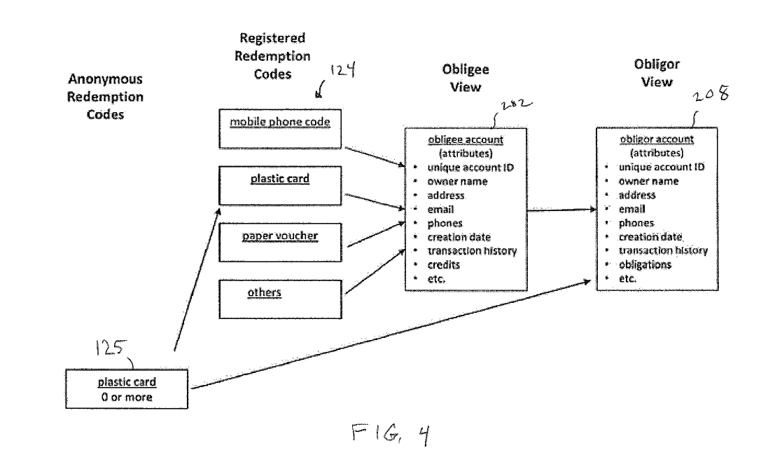

FIG. 4 illustrates information that may be available about registered and non-registered (i.e., anonymous) cards 124, 125, and the information (e.g., attributes) that may be available to the consumer through the consumer account 202 and the merchant through a merchant account 208. The embodiment of FIG. 3 shows a single merchant system. In some embodiments, non-registered cards 125 may have a balance thereon, but may not be managed through a consumer account. In some embodiments, a consumer may select a card 125 to be registered but remain anonymous, which the consumer may select through an online registration process for anonymous cads.

The consumer account 202 may enable the consumer to view attributes associated with the consumer account itself, such as the unique account ID, owner name, address, email, phones, account creation date, transaction history, credits, etc. The merchant account 208 may enable the merchant to view attributes associated with the merchant account itself, such as the unique account ID, owner name, address, email, phones, account creation date, transaction history, credits, etc.

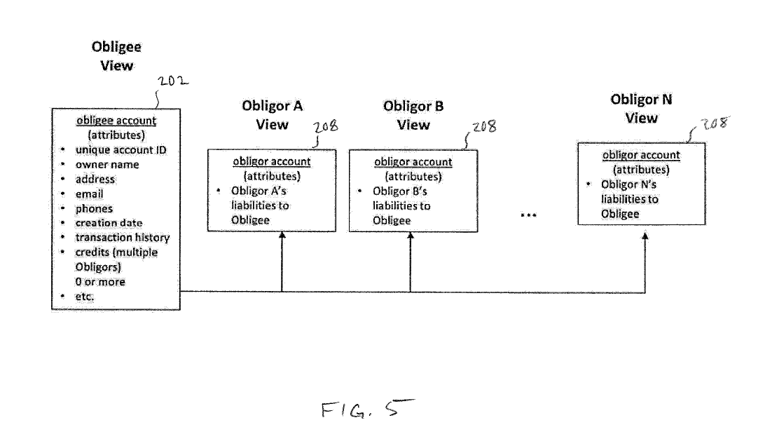

FIG. 5 illustrates information (e.g., attributes) that may be available to the consumer through the consumer account 202, as well as to each merchant through its respective merchant account 208. The embodiment of FIG. 5 shows a multiple merchant system. The consumer account 202 may enable the consumer to view attributes associated with the consumer account itself, such as the unique account ID, owner name, address, email, phones, account creation date, transaction history, credits, etc. The credits may be organized according to the corresponding merchant that has the corresponding liability.

The merchant account 208 may enable the merchant to view attributes associated with the merchant account itself, such as the unique account ID, owner name, address, email, phones, account creation date, transaction history, etc. Each merchant account 208 may also enable the merchant to view the merchant's liabilities to the various consumers to which is has a liability, which liabilities may be organized according to consumer claiming them as assets.

In some embodiments, consumers may also enter into non-fungible contractual relationships with merchants through direct interactions with a merchant. For example, offers may be presented to the consumer through the merchant's web site, or through a purchase at the merchant's storefront. Entering into such a contractual relationship may likewise add assets 122 that are available for redemption by the consumer for the universal card 124. These additional assets 122 are seen as liabilities to the corresponding merchants.

In some embodiments, consumers may also enter into non-fungible contractual relationships through third-party partners of the merchant. For example, offers may be presented to the consumer through a third-party web site (e.g., deal web sites, on-line newspapers, travel agencies, etc.). As an example, a daily deal web site (e.g., Groupon) may offer local or national deals for a variety of different merchants. The consumer may become aware of the offer and enter into contractual relationships through the daily deal web site, and the assets are made available for redemption by the consumer for the universal consumer card 124. Other third-party web sites may include on-line news web sites or any other web site that may display advertisements, classifieds, or other offers for third parties. Providing such offers may provide additional revenue to the third-party web sites for generating leads for merchants that result in a contractual relationship with a consumer. As a result, the system 100 may be utilized by media companies to strengthen local merchant relationships with co-branded offers, which can also lead to new payment methods for traditional advertising.

As discussed briefly above, access to the linked databases 113 of the card data and redemption center 110 may be performed via web-based computer programs, such as browsers and APIs 114, 116, 118. For example, consumer data may be passed through a consumer API 114, which allows consumers to enter consumer data (e.g., name, address, email address), view consumer data related to their universal card account (e.g., current balances, transaction history, etc.), manage consumer data (e.g., purchase offers, enter offers, etc.). The consumer may link to the consumer API 114 and access consumer data through a web-enabled device (e.g., computer, tablet, smart phone, etc.), such as through a web browser, application, or other interface. In response to accepting an offer, an asset is assigned to the consumer and a liability is assigned to the appropriate merchant in the linked databases 113.

Offeror data may be passed through an offeror API 116, which allows offerors 130 access to the universal redemption center software platform 112 to generate, extend, track, cross-reference, manage, and validate offers. For example, offerors 130 may provide an interface through their own website to link to the card data and redemption center 110. As a result, the offeror 130 may provide access to its customers to inventory managed by the card data and redemption center 110. As a result, the offerors 130 may be able to offer more inventory to their customers and with little to no overhead than they otherwise would be able to if they were to be administrators of their own system. Thus, offerors 130 may receive revenue through purchases that original through their website. In addition, the offeror 130 may be able to provide offers to their own consumers without needing to manage the redemption back-end services. Offerors 130 may have some access to data related to consumers, such as those that have accepted and/or redeemed offers. The offeror 130 may access offeror data through a web-enabled device (e.g., computer 132, tablet, smart phone, etc.), such as through a web browser, application, or other interface.

In some embodiments, offerors 130 may be third-party offerors that provide offers for one or more merchants associated with the system 100. In other words, third parties may access the universal redemption center software platform 112 via Internet-based computer programs such as browsers and APIs to create redemption center opportunities for merchants and consumers. Such opportunities include, but are not limited to, third-party offers, offer syndication services, marketing services, and other benefits. As an example, third-party offerors 130 may include deal space web sites specifically configured to provide offers from different merchants. Third-party offerors 130 may also include web sites that may provide their own content, but which may solicit advertising partners (e.g., merchants) to generate revenue. As a result, such third-party offerors 130 may provide functionality with their advertisements to provide offers directly from the third-party web site. In some embodiments, offerors 130 may be merchants that provide their own offers. In other words, merchant offerors 130 may access the universal redemption center software platform 112 via Internet-based computer programs such as browsers and APIs to create redemption center opportunities for themselves and consumers. As an example, merchant offerors 130 may include a merchant web site specifically configured to provide offers for the services, products, events, etc. provided by the merchant itself.

The offeror API 116 and/or other web interfaces may allow consumers, merchants, and third parties access to the universal redemption center software platform 112 through interfaces provided by the administrator (e.g., Kostizi) of the system 100. Such access may be through web-enabled devices 140, such as computers 142, smart phones 144, tablets, etc. that may access a web site associated with the administrator of the system 100. For example, consumers may access the universal redemption center software platform 112 to a consumer account to view, accept, track, cross-reference offers as well. Merchants may have access to a merchant account to view and interact with a management portal of the universal redemption center software platform 112. Third-party media partners may also be provided with back-office access. As stated, such access may be through web sites created by the administrator, rather that merchants or third parties.

Redemption of assets may occur through a redemption API 118, which allows consumers and merchants engage in a redemption transaction involving their respective assets and liabilities. In some embodiments, redemption may be initiated by the merchant with a web-enabled device 150 (e.g., computer 151, tablet 152, smart phone 153, POS terminal 154, etc.), such as through a browser, application, or other interface. As an example, if the consumer presents a physical universal consumer card 126 to the merchant, the merchant may utilize the web-enabled device 150 to read the account information with a bar code, magnetic stripe, etc. In some embodiments, the merchant may manually enter a unique identifier (e.g., account number) associated with the physical universal consumer card 126. The web-enabled device 150 may request information from the card data and redemption center 110 verifying that the consumer has a valid balance related to the merchant. The web-enabled device 150 may also transmit the transaction information to the card data and redemption center 110 through the redemption API 118 in order to update the linked databases 113. As a result, the asset for the consumer may be correspondingly reduced. In addition, the corresponding liability for the merchant may also be reduced. The administrator of the system 100 may receive a transaction fee. Additional information regarding the transaction (e.g., consumer name, preferences, etc.) may also be recorded in the linked databases 113, which may provide additional tracking, verification, and other desirable data to the merchant for improving marketing and other consumer retention activities.

In some embodiments, the web-enabled device 150 of the merchant may be configured to include a single button redemption feature. For example, after consumer credentials have been entered (e.g., scan, swipe, type, etc.) into the merchant's web-enabled device 150, the interface presented to the merchant on the web-enabled device 150 may provide the merchant with the option to redeem assets of the customer associated with that merchant. If the merchant selects the redeem button, the interface may query the linked databases 113 and display the assets of the consumer associated that merchant. The consumer may have a plurality of different types of assets for a given merchant. For example, the merchant's interface may show that the consumer has a gift card balance, a deal voucher, a coupon, or other non-fungible assets associated with the merchant. Each of these assets may be viewable by the merchant through a single interface and selectable for redemption. The merchant may ask the consumer which, if any, of the assets the consumer would like to redeem, after which the merchant may select to redeem through the merchant's web-enabled device 150.

In some embodiments, redemption may be initiated by the consumer with a web-enabled device (e.g., smart phone, tablet, etc.), such as a virtual universal consumer card 128. As an example, the consumer may receive a bill from the merchant, such as a restaurant. The consumer may use have a web-enabled device (e.g., a smart phone) that may have access to the card data and redemption center 110. The consumer may view assets for different merchants, and choose which asset(s) to redeem. For example, a coupon, gift card balance, deal voucher, etc. may be applied toward the bill. In some embodiments, the consumer may do a search while at the merchant to see if any offers are available to be accepted and added to their assets. If the consumer selects redemption of an asset, the asset for the consumer may be reduced. In addition, the corresponding liability for the merchant may also be reduced. The administrator of the system 100 may receive a transaction fee. In card data and redemption center 110 may also send a confirmation message to a web-enabled device 150 of the merchant confirming that the transaction is complete. Thus, the staff at the merchant may have any type of web-enabled device 150 that displays a message indicating that the bill has been paid, and that the consumer has met their obligations.

In some embodiments, the consumer may initiate redemption of an asset prior to receiving a bill. For example, the consumer may redeem an asset, updating the assets and liabilities, and transmitting a confirmation message to the merchant as described above. While examples are provided in terms of a bill, redeeming other assets (e.g., event tickets, entrance fees, etc.) may likewise be redeemed in a similar manner.

The interface used by the consumer for on-site redemption may be a single-button interface, such as an application that links to the redemption API 118. In some embodiments, the consumer may need to enter the particular merchant for which the asset is to be redeemed. In other embodiments, the web-enabled device of the consumer may detect a location of the consumer (e.g., through GPS data) and determine the appropriate merchant based on that location.

In summary, each of the APIs 114, 116, 118 may provide interfaces to enable interaction with the universal redemption center software platform 112. More specifically, the APIs 114, 116, 118 may enable properly authenticated outside computer applications to create, read, update, and delete merchant and consumer records in the linked databases 113. Various collections of APIs 114, 116, 118 may enable outside computer applications wide latitude insofar as extending the universal redemption center software platform 112. The APIs 114, 116, 118 for the universal redemption center software platform 112 describe and prescribe the expected behavior of the library of software functions and the rules that govern the behavior of the universal redemption center software platform 112.

The APIs 114, 116, 118 enable software applications to communicate with the universal redemption center software platform 112 over the Internet through a series of calls. The APIs 114, 116, 118 may define the specific methods and protocols with which outside computer applications communicate with the universal redemption center software platform 112. With the APIs 114, 116, 118, the calls back and forth between the outside computer applications and the universal redemption center software platform 112 may be managed through a variety of different types of web services. Web services are a collection of technological standards and protocols, which may include but not limited to XML (Extensible Markup Language) or other similar programming language by which applications or programs may communicate over the Internet.

With the APIs 114, 116, 118, authorized application programmers may be permitted to make use of and extend the capabilities of the universal redemption center software platform 112. In other words, the administrator of the system 100 may provide the APIs 114, 116, 118 and a series of software development kits (SDKs) that allow software developers to create programs that may enable offerors to create, manage, promote, track, and validate non-fungible contractual assets and liabilities that can be uniquely identified, tracked, and redeemed, resulting in a reduction of liability for the merchants and redemption of value for the consumers. The APIs 114, 116, 118 and SDKs may enable computer programmers to (1) access the universal redemption center software platform 112 in order to generate, extend, track, cross-reference, manage, and validate offers, (2) access the universal redemption center software platform 112 to track, cross-reference, extend, and manage a consumer's assets, and (3) access the universal redemption center software platform 112 to create redemption center opportunities for merchants and consumers. Such opportunities include but are not limited to third-party offers, offer syndication services, marketing services, merchant offers, and other beneficial services.

Thus, embodiments hereof that utilize such a web-enabled software platform may provide a much larger pool of potential merchants that participate in the system 100. Thus, merchants may be retailers, service providers, entertainment venues (e.g., sports, concerts), restaurants, clubs, community clubs, schools, pharmacies, and any other merchant that may provide offers, but may be reluctant to participate in conventional systems for one or more of the reasons described above.

In addition, embodiments of the disclosure may contribute to the merchant attracting new consumers, encouraging current consumers to return more often, bring greater efficiency and measurable results to your advertising, streamline and simplify how merchants present, redeem, and manage offers to consumers, reduced paper work and employee training, reduced fraud, which may all lead to an improved bottom line. In addition, reducing the number of cards and other paper certificates may contribute to a “greener” system that reduces waste associated with manufacturing and discarding large number of cards and papers after a single use. Embodiments of the disclosure may also attract additional revenue from third-party partners interested in new revenue opportunities, strategic offset to online threats, re-establishing local relationships with merchants and consumers, etc.

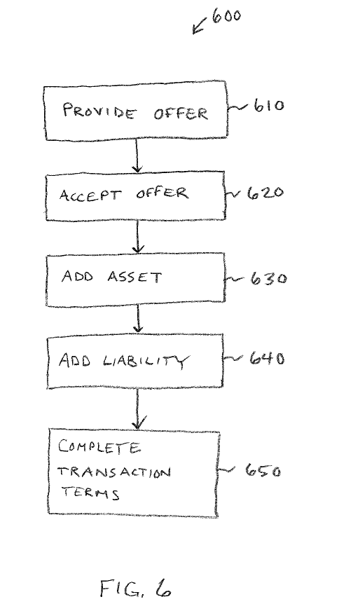

FIG. 6 is a flow chart 600 illustrating a method for establishing a contractual relationship between a consumer and a merchant according to an embodiment of the disclosure. At operation 610, an offer is provided to a universal card data and redemption center 110. Such an offer may be associated with a merchant. As an example, a merchant may offer a deal voucher for an $80 credit to the merchant, for which the consumer may only spend $40. The offer may be provided directly by a merchant (e.g., through a merchant's web site), or through third-party offerors (e.g., deal space web sites, on line content providers, etc.) that may present offers for a plurality of different merchants.

At operation 620, the consumer may accept the offer. The offer may be accepted at any such merchant or third-party entity or web site, or through a personal account web site maintained by the administrator of the universal consumer card. At operation 630, an asset associated with that merchant may be added in the consumer's account in the linked databases 113. For example, the consumer account may include an $80 credit for that merchant. At operation 640, a corresponding liability may be added to the merchant's account in the linked databases 113. For example, the merchant account may include an $80 liability associated with that consumer. At operation 650, the transaction terms are completed for establishing the contractual relationship. For example, the administrator may receive the funds (e.g., $40) from the consumer, retain a commission (e.g., 10%=$4), with the remaining balance (e.g., $36) being paid to the merchant. If a third-party offeror was involved, the third-party offeror may also be paid a commission for generating the lead.

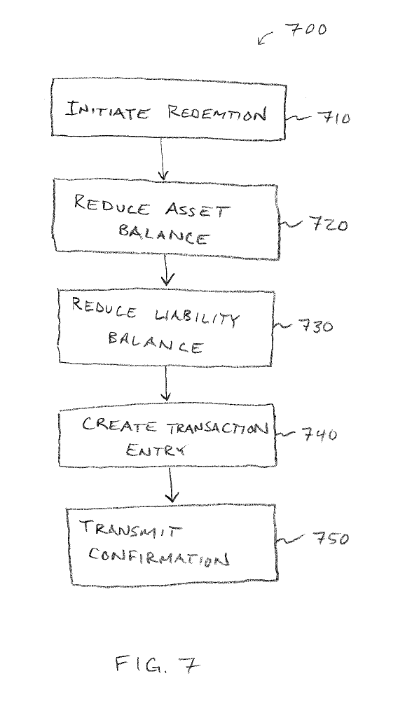

FIG. 7 is a flow chart 700 illustrating a method for redeeming an asset of a consumer according to an embodiment of the disclosure. At operation 710, redemption may be initiated. For example, redemption may be initiated by the merchant or the consumer as described above. At operation 720, the desired asset in the consumer's account associated with the merchant is reduced in the linked databases 113 by the redeemed amount (e.g., $80). At operation 730, the corresponding liability for the merchant in the merchant's account is reduced in the linked databases 113 by the redeemed amount (e.g., $80). The redeemed amount may be the entire asset, or a portion thereof. At operation 740, a transaction entry may be created in the linked databases that includes additional transaction data related to the consumer and merchant. At operation 750, confirmation of the completed transaction may be transmitted to the merchant, consumer, or both.

Redemption may be assisted through the use of the digits of a consumer's access mechanisms (asset ID) and the merchant's access mechanisms (liability ID). The probability of account conflict between the merchant and the consumer may be reduce if a smaller number of least significant digits (e.g., 4 least significant digits) of the access mechanisms may be utilized to uniquely identify the consumers account and assets. In the event that a conflict may arise, the merchant may be presented with a matching set of the consumer to resolve account identification ambiguities.

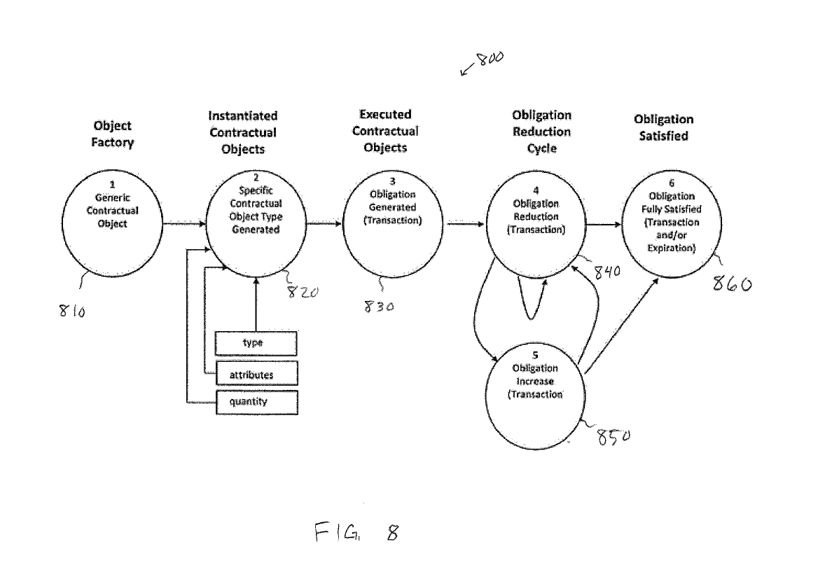

FIG. 8 is a flow diagram 800 illustrating a life span of an object generated with the creation of a non-fungible contractual liability between a consumer and a merchant. The data object may be stored in the linked databases 113 (FIG. 1), which may enable the card data and redemption center 110 to manage, link, edit, delete, parse, etc. the object itself as well as the attributes therein. At operation 810, the object may be generated as a generic contractual object. At operation 820, the object may be provided with attributes to generate a specific contractual object type that is stored in the linked databases 113. At operation 820, the obligation associated with the object may be generated, such as by the consumer entering a transaction with the merchant and the initial balance may be stored with the object.

At operation 840, the obligation may be reduced (e.g., by a redemption transaction). As a result, the balance/credit attribute may be updated to reflect the current balance. In addition, other attributes may be updated, such as to reflect a transaction date, card type used in the transaction, and other information that may be tracked with regard to the transaction. At operation 850, the obligation may be increased (e.g., by adding a balance in a transaction). As a result, the balance/credit attribute may be updated to reflect the current balance. In addition, other attributes may be updated that may be tracked with regard to the increased transaction. At operation 860, the obligation may be fully satisfied. For example, the entire remaining balance may be redeemed. In some situations, the obligation may be fully satisfied according to the terms of the obligation (e.g., an expiration date). As a result, the data object may be updated to reflect the current (zero) balance as well as any other attributes that may be desirable for tracking purposes. In some embodiments, the data object may be removed from the linked databases and/or deleted. However, the historical data on the data object may be desirable to remain present for the merchant and/or the purchaser to have such information available.

Although the foregoing description contains many specifics, these are not to be construed as limiting the scope of the disclosure, but merely as providing certain exemplary embodiments. Similarly, other embodiments of the disclosure may be devised which do not depart from the scope of the disclosure. For example, features described herein with reference to one embodiment also may be provided in others of the embodiments described herein. The scope of the claimed invention is, therefore, indicated and limited only by the appended claims and their legal equivalents, rather than by the foregoing description.

What is claimed is:

1. A universal consumer card redemption system comprising:
a universal software platform including a network of linked databases configured to store data associated with contractual relationships between at least one consumer and a plurality of different merchants; and
at least one web-based interface configured to communicate with at least one of a universal consumer card associated with a consumer and web-enabled device associated with a merchant, the at least one web-based interface providing the web-enabled device with a single-button redemption feature configured to present at least one asset of the consumer for a particular merchant and redemption options to the merchant responsive to receiving a query request via an interface of the web-enabled device.

2. The universal consumer card redemption system of claim 1, wherein the query request includes merchant account information sent by the consumer.

3. The universal consumer card redemption system of claim 1, wherein the query request includes consumer account information sent by the particular merchant.

4. The universal consumer card redemption system of claim 2, wherein the at least one asset of the consumer presented to the merchant includes a plurality of different asset types.

5. The universal consumer card redemption system of claim 4, wherein the plurality of different asset types are selected from the group consisting of coupons, vouchers, gift certificates, event tickets, deals, rewards points, fees, gift cards, ownership claims for products or services, pre-paid prescriptions, appointments, and digital representations of the same.

6. The universal consumer card redemption system of claim 4, wherein the single button redemption feature is made available for the merchant to select responsive to consumer credentials being entered into the web-enabled device associated with the merchant.

7. The universal consumer card redemption system of claim 6, wherein the web-enabled device associated with the merchant is configured to receive the consumer credentials from at least one of scanning the universal consumer card, swiping the universal consumer card, and manually entering the consumer credentials associated with the universal consumer card.

8. A web-enabled device configured for use with a universal card redemption system, the web-enabled device configured to:
display an interface to a merchant, the interface having a single button redemption feature;
query a plurality of linked databases to determine an existence of at least one asset of a particular consumer associated with the merchant in response to the single button redemption feature being selected; and
display the at least one asset of the particular customer associated with the merchant in response to the query.

9. The web-enabled device of claim 8, further configured to redeem the at least one asset in response to a user selecting the at least one asset displayed by the web-enabled device following the query.

10. The web-enabled device of claim 8, wherein the web-enabled device is selected from the group consisting of a computer, tablet, smart phone, and POS terminal.

11. The web-enabled device of claim 8, wherein the web-enabled device is further configured to receive consumer account information for the particular consumer.

12. The web-enabled device of claim 11, wherein the web-enabled device is configured to receive the consumer account information by at least one of scanning a bar code, reading a magnetic stripe, and manually entering a unique identifier.

13. The web-enabled device of claim 8, wherein the at least one asset of the particular consumer associated with the merchant includes all assets of the particular consumer currently associated with the merchant.

14. A method for redeeming an asset from a consumer account, comprising:
selecting a query button on an interface displayed by a web-enabled device;
querying a database including data objects associated with a plurality of assets linked to a plurality of consumer accounts;
receiving a list having at least one asset linked to a particular consumer account of the plurality that is associated with a particular merchant; and
redeeming the asset through the interface.

15. The method of claim 14, wherein querying includes sending account information for the particular consumer account to the database.

16. The method of claim 15, wherein receiving a list having at least one asset linked to a particular consumer account includes receiving a list having all assets currently linked to the particular consumer account.

17. The method of claim 14, further comprising receiving a message on the web-enabled device indicating that the asset has been redeemed.

18. The method of claim 14, wherein selecting a query button is initiated by the web-enabled device associated with the particular consumer account.

19. The method of claim 18, wherein querying includes sending account information for the particular merchant account to the database.

20. The method of claim 19, further comprising obtaining account information for the particular merchant by detecting a location of the web-enabled device and determining the particular merchant based, at least in part, on the detected location.
